(19) United States
(12) Patent Application Publication
(10) Pub. No.: US 2002/0148851 A1
(43) Pub. Date: Oct. 17, 2002

(54) SDS gas bottle thermo pressurizer

(76) Inventors: Stephen Toy, Auburn, CA (US); Baldwin B. Chiu, Rancho Cordova, CA (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 09/834,006

(22) Filed: Apr. 12, 2001

(51) Int. Cl. B67D 5/14; B67D 5/62

(52) U.S. Cl. 222/3; 222/64; 222/146.5; 222/1; 222/394

(57) ABSTRACT

A method and apparatus for extending the useful operating life of a low-pressure gas bottle for use in a semiconductor device manufacturing process. As the gas bottle is detected to be approaching an empty condition, the gas in the bottle is safely heated in a manner that causes gas molecules to be released from an absorbent material used in the bottle. In a preferred embodiment, a thermo-pressurizer, including a heating blanket that surrounds the gas bottle and a temperature controller coupled to the heating blanket, causes the pressure in the gas bottle to be elevated, thereby releasing gas molecules from the absorbent material.

### BACKGROUND OF THE INVENTION

1. Field of the Invention

The invention relates to semiconductor device fabrication techniques, and, more particularly, to a gas-delivery system that includes of a method and apparatus for extending the operating life of a low-pressure gas bottle.

2. Description of the Related Art

As accommodation to safety considerations, Safe Delivery Source (SDS) gas bottles are used in semiconductor device fabrication facilities. SDS gas bottles effect safety enhancements by delivering gasses, such as phosphine, that are used in semiconductor fabrication processes, at low pressure. Low-pressure operation of SDS gas bottles is predicated on immersion of the gas in an absorbent material, such as carbon. SDS gas bottles are available from a number of suppliers, including Matheson Tri-Gas, Inc., Parisipanny, N.J.

In practice, the flow of gas from the SDS bottle to the respective semiconductor processing equipment is controlled by vacuum techniques according to which gas is drawn from the bottle. However, as the gas in the bottle approaches very low pressures, flow of gas from the bottle necessarily diminishes, often leaving a substantial amount of available gas in the bottle. For example, it has been empirically determined that as much as 30% to 50% of gas molecular material remains trapped in the absorbent subsequent to the time at which gas flow has effectively terminated. The heretofore unavoidable inability to utilize the entire gas portion in a bottle exacerberates the characteristically high expense associated with SDS gas bottles.

Redesigned mass flow controllers (MFCs) have been looked to in an attempt to mitigate the economic drawbacks attendant SDS bottles. Although this approach has resulted in some improvement, the operational life of SDS gas bottles remains lower than desired.

Accordingly, what is sought is a technique for improving the operating life of an SDS gas bottle, while maintaining the desired safety-related attributes of the gas-delivery system. In a manner to be described in detail below, the subject invention significantly extends the operational life of an SDS gas bottle and, consequently, increases production efficiency, decreases the amount of labor required to change out SDS gas bottles and otherwise reduces the expense associated with the use of SDS gas bottles.

### SUMMARY OF THE INVENTION

The above and other objects, advantages and capabilities are achieved in one aspect of the invention by a gas-delivery system for use in a semiconductor device fabrication process. The essence of the gas-delivery system resides in a low-pressure gas bottle, combined with a thermo-pressurizer for extending the operating life of the gas bottle. As particularized, the system includes an SDS gas bottle and the thermo-pressurizer that is implemented in the form of a heat blanket that is thermally coupled to the SDS bottle. The operation of the heat blanket is controlled by a temperature controller.

From an alternative perspective, the invention includes a method of increasing the operating life of a gas-bottle used in a semiconductor manufacturing process, wherein the gas bottle is coupled to semiconductor processing equipment through a mass flow controller (MFC). The method comprises disposing a heating blanket in proximity to the gas bottle so as to be thermally coupled to the gas bottle, electrically coupling the heating blanket to a thermal controller, and coupling an ALARM output of the MFC to the thermal controller.

In another aspect, the invention is practiced as a method of increasing the operating life of a low-pressure gas bottle used in a semiconductor device manufacturing process. According to the method, the gas bottle is coupled to a thermo-pressurizer. When a predetermined condition is detected, the thermo-pressurizer is operated so as to cause the pressure in the bottle to increase. The invention is particularly applicable to SDS gas bottles.

In another embodiment, the invention is encountered in a semiconductor device fabrication process that includes a method of extending the operating life of a low-pressure (for example, SDS) gas bottle. A heating blanket is disposed in proximity to the gas bottle so as to be thermally coupled to the gas bottle. The heating blanket is in turn coupled to be a source of current. When a predetermined condition is detected with respect to the gas bottle, current is caused to be supplied to the heating blanket, resulting in heat transfer from the blanket to the gas bottle.

### BRIEF DESCRIPTION OF THE DRAWINGS

The present invention may be better understood, and its numerous objects, features, and advantages made apparent to those skilled in the art by referring the accompanying Drawings, in which:

FIG. 1 is a depiction of thermo-pressurizer for an SDS gas bottle; and the use of the same reference symbols in different drawings indicates similar or identical items.

FIG. 2 illustrates the interconnection of an SDS gas bottle, a mass flow controller (MFC) and a temperature controller.

### DETAILED DESCRIPTION

For a thorough understanding of the subject invention, reference is made to the following Description, including the appended Claims, in conjunction with the above described Drawings.

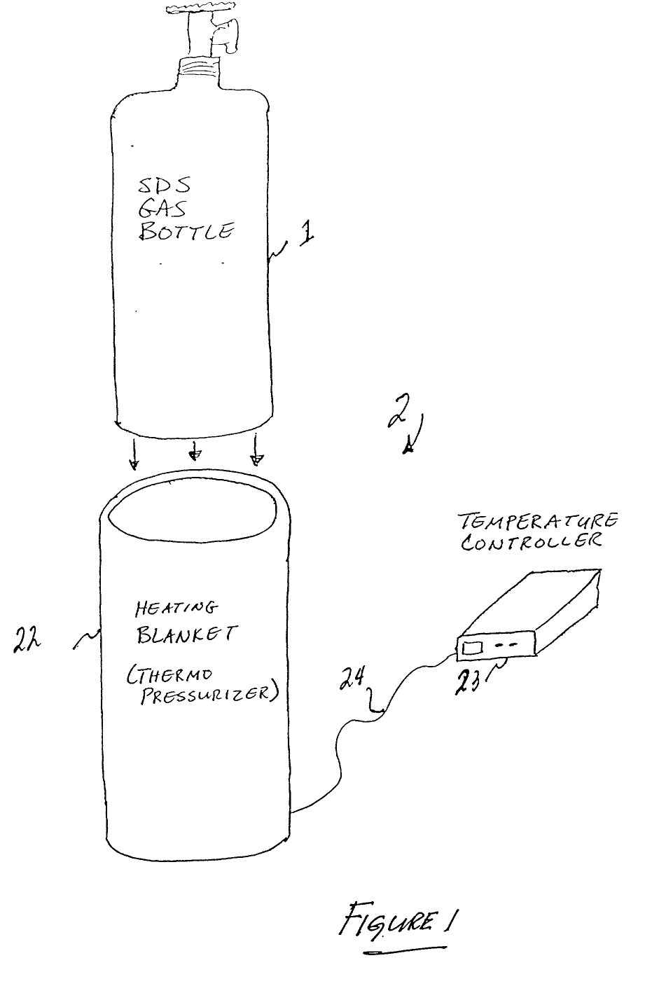

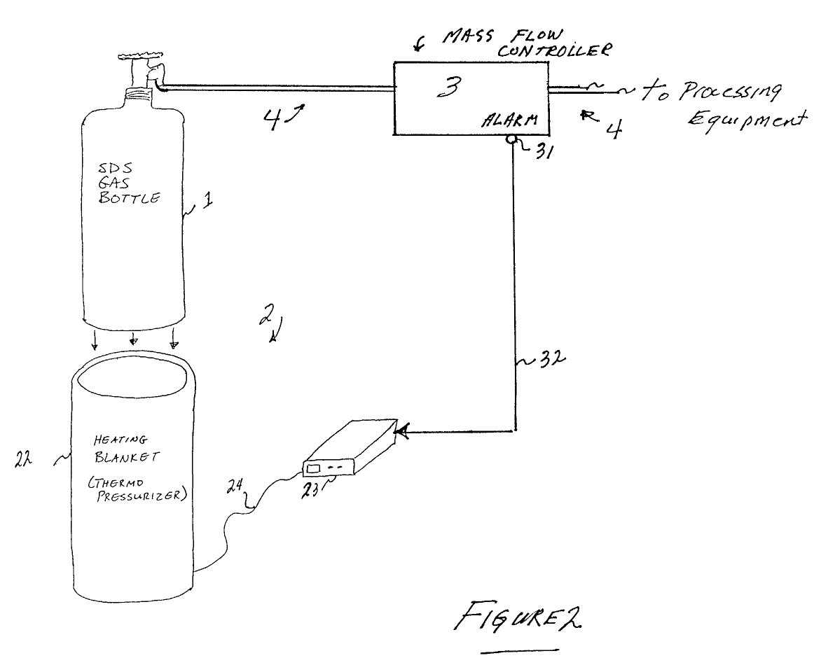

As is well known, many stages of a semiconductor device fabrication process require the delivery of gas to processing equipment, such as reaction chambers. For example, gasses such as PH₃, A_{S}Cl₃ or BCl₃ may be used as a dopant for semiconductor crystals. In addition, PH₃ (phosphine) and other gasses are used in silicon epitaxy, where the dopant concentration of an epitaxial layer is controlled by metering the flow of gasses into a reaction chamber. See, for example, Stephen A. Campbell, The Science and Engineering of Microelectronic Fabrication, Oxford University Press (1996). Many such gasses, phosphine included, are both poisonous and highly flammable. As a safety measure, Safe Delivery Source (SDS) gas bottles are now regularly used in semiconductor device fabrication facilities. However, as indicated above, SDS gas bottles, which deliver gas at low pressure, are accompanied by relatively high cost, and the initial high cost of acquisition is aggravated by the difficulty encountered in drawing all the contained gas from the SDS bottle. Abatement of this detriment may be had by resort to the subject invention, an SDS Gas Bottle Thermo-Pressurizer, a preferred embodiment of which is depicted in FIG. 1.

Referring now to FIG. 1, a typical SDS gas bottle 1, is seen to exhibit a generally cylindrical contour. Gas bottle 1 is coupled to semiconductor processing equipment, such as a reaction chamber (not shown), through an MFC and ¼″ stainless steel tubing. Delivery of gas from bottle 1 to the semiconductor processing equipment is rendered substantially more efficient, economically, as well as thermodynamically, through the operation of thermo-pressurizer 2 that includes heating means in the form of a heat blanket 22 and control means in the form of a temperature controller 23. In practice, the heat blanket 22 is thermally coupled to the SDS gas bottle by wrapping the blanket around the bottle. To this end, and as seen in FIG. 1, heat blanket 22 is configured to complement, or conform, to the contour of the SDS gas bottle. Because the SDS gas bottle is generally cylindrical in form, the heat blanket is accordingly configured to be generally tubular. In the presumably unlikely event that gas bottles are encountered with other than cylindrical contours, heat blanket 22 may be easily reconfigured. Heat blanket 22 is of the type, well know in the art, that generates thermal energy, in proportion to the current caused to flow in resistive elements (not shown) embedded and dispersed throughout in the heat blanket. As shown in FIG. 1, heat blanket 22 is electrically coupled, as by cable 24, to temperature controller 23. Temperature controllers of the type used herein may be obtained from numerous sources, including, for example, Watlow Controls, Winona, Minn. In a method to be more precisely articulated below, temperature controller 23 operates in response to a predetermined detected state of the SDS gas bottle to supply current to heat blanket.

Specifically, when the gas bottle is detected to be in an apparent empty condition, temperature controller 23 operates to deliver current to the heating elements of heat blanket 22. Heat thereby dissipated in heat blanket 22 is transferred to gas bottle 1 so as to elevate the temperature of the gas remaining in the bottle. In one embodiment, the gas temperature is elevated to approximately 105° F. As the temperature of the contents of the gas bottle rises, the internal pressure increases. Consequently, gas molecules that had been previously trapped in absorbent material are released, and gas flow from the bottle to the processing equipment is extended. When it is determined that no appreciably additional gas flow may be promoted by the continued application of heat to the gas bottle, temperature controller 23 operates to discontinue the delivery of current to heat blanket 22.

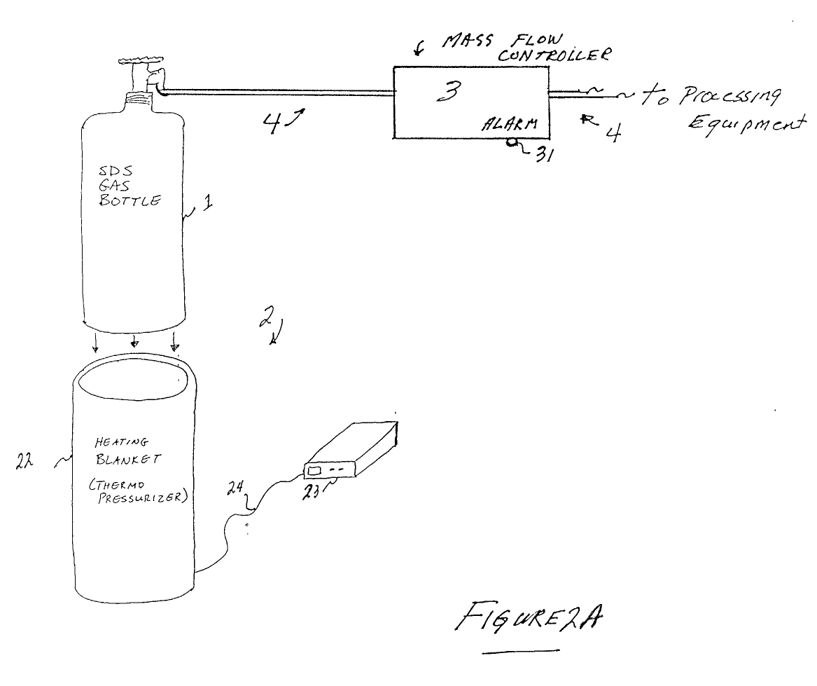

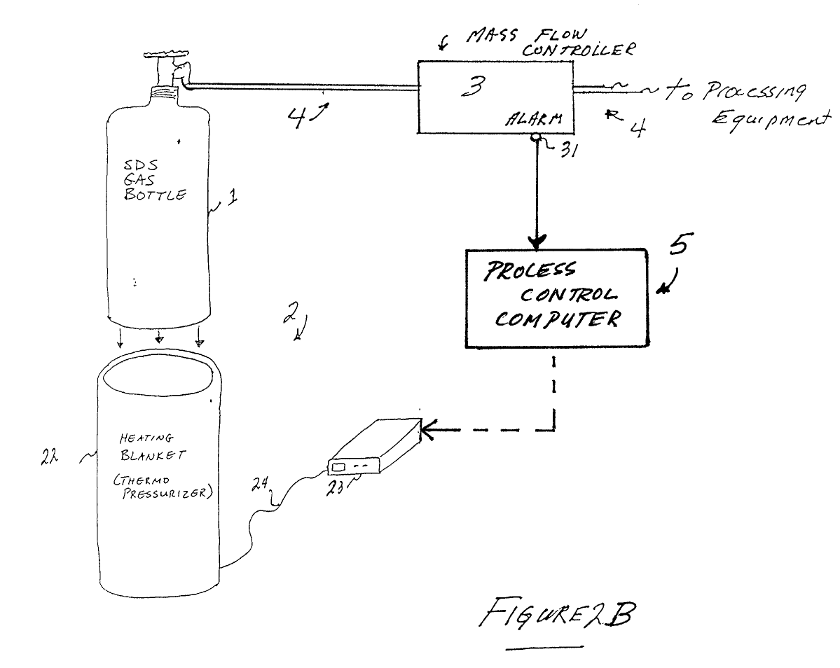

FIG. 2A illustrates the interconnection of the SDS gas bottle 1, thermo-controller 2 (including heating blanket 22 and temperature controller 23), and an MFC 3. Gas from SDS bottle 1 flows to semiconductor processing equipment (not shown) via stainless steel tubing 4 through MFC 3. MFC 3 is, in turn, electrically coupled through conductor 32 to temperature controller 23. A common operational feature of MFCs used in semiconductor processing is the generation of a electrical signal, an ALARM, when gas flow falls below a predetermined threshold. For purposes of understanding this invention, it may be assumed that the ALARM signal, at output 31, is a logic-level ONE or some other predetermined DC voltage level. The ALARM signal is provided to temperature controller 23 so as to initiate (or increase) the current provided to heat blanket 22, thereby stimulating gas flow. As the gas flow through MFC 3 increases, the ALARM signal will disappear. However, temperature controller 23 will remain active. Ultimately, gas in the bottle will be substantially exhausted, or at least reduced to a concentration too low to benefit from continued application of heat to the bottle. Consequently, the MFC ALARM will reoccur. When the second occurrence of the ALARM is observed by a technician, the exhausted SDS bottle will be replaced.

In an alternative embodiment illustrated in FIG. 2B, the ALARM output of MFC may be coupled to a process control computer 5, rather than directly to temperature controller 23. In this case, process control computer 5 would annunciate an ALARM signal that is coupled to the temperature controller 23. As a further variation, the invention also contemplates embodiments in which the ALARM signal, whether generated by MFC 3 or process control computer 5, is not directly coupled to the temperature controller. The ALARM may in these instances be either audible or visible and, when detected by an operator, result in manual activation of the temperature controller so as to apply current to heating blanket 22.

Deployment of the inventive technique described above has been proven to substantially extend the operating life of an SDS gas bottle. At least in one instance, an SDS gas bottle used in a semiconductor manufacturing process required periodic replacement at approximately 2.5-month intervals. Application of the inventive technique has been found in at least one application to extend the operating life of an SDS gas bottle an additional three months. In a particular process in which the thermo-pressurizer was deployed, the extended operating life of the SDS gas bottles corresponded to the processing of roughly 40,000 additional semiconductor wafers.

Accordingly, although the subject invention has been articulated with respect to the specific exemplary embodiment disclosed in the Description above, the invention is not limited to a single embodiment. Various modifications, additions or improvements may be devised by artisans with ordinary skill. Such modifications, additions and improvements are to be comprehended as within, or deemed equivalent to, the literal scope of the invention as defined by the appended Claims. In particular, although the utility of the invention has been established contextually with respect to semiconductor manufacturing process, the invention is clearly applicable in any milieu relying on low-pressure gas bottles. Furthermore, the invention is not restricted to use in association with low-pressure bottles of the SDS type. The salient aspect of the invention is simply the detection of a significant diminution in the flow of gas from the bottle and the delivery of energy to the bottle in a manner that promotes additional gas flow.

What is claimed is:

1. A method of increasing the operating life of a low-pressure gas bottle used in a semiconductor device manufacturing process, the method comprising the steps:
coupling the gas bottle to a thermo-pressurizer;
detecting a condition of the gas bottle; and
in response to the condition, operating the thermo-pressurizer to enable additional gas to flow from the gas bottle.

2. A method as defined in claim 1, wherein the condition is an apparent empty state.

3. A method as defined in claim 2, wherein in response to detection of the condition, the thermo-pressurizer is operated to safely raise the temperature of the gas bottle sufficiently to cause gas molecules to be released from an absorbent material used in the gas bottle.

4. A thermo-pressurizer for extending the operating life of a low-pressure bottle that is used in a semiconductor device manufacturing process, the thermo-pressurizer comprising:
heating means for thermally coupling to the gas bottle and for causing gas molecules to be released from an absorbent material used in the gas bottle; and
control means electrically coupled to the heating means for causing the temperature of the heating means to be elevated upon the detection of a predetermined condition of the gas bottle.

5. A thermo-pressurizer as defined in claim 4, wherein the heating means is a blanket that conforms to the contour of the gas bottle and the control means is a temperature controller.

6. A thermo-pressurizer as defined in claim 5, wherein the control means is a temperature controller for delivering current to the heating means when the gas bottle is detected to be in an apparent empty condition.

7. A method of increasing the operating life of a gas-bottle used in a semiconductor manufacturing process, wherein the gas bottle is coupled to semiconductor processing equipment through a mass flow controller (MFC), the method comprising:
disposing a heating blanket in proximity to the gas bottle so as to be thermally coupled to the gas bottle;
electrically coupling the heating blanket to a controller; and
coupling an ALARM output of the MFC to the controller.

8. A method as defined in claim 7, further comprising:
detecting at the MFC a predetermined condition of the gas bottle; and
in response to an initial detection of the predetermined condition, applying a first occurrence of an ALARM signal to the controller, thereby causing the controller to cause the heat blanket to raise the level of heat applied to the gas bottle.

9. A method as defined on claim 8, further comprising:
in response to a subsequent detection of the predetermined condition, applying a second occurrence of the ALARM signal to the controller; and
upon detection of the second occurrence of the ALARM signal, disengaging the gas bottle.

10. A method as defined on claim 9, wherein the gas bottle is disengaged manually.

11. A method as defined in claim 8, wherein the predetermined condition is near-empty condition.

12. A method as defined in claim 8, wherein the controller raises the level of the current applied to the heat blanket in order to raise the temperature of the gas in the gas bottle.

13. A gas-delivery system for a semiconductor device fabrication process, the gas-delivery system comprising:
a low pressure gas bottle; and
a thermo-pressurizer coupled to the gas bottle for extending the operating life of the gas bottle.

14. A gas-delivery system as defined in claim 13, wherein the gas bottle contains a gas immersed in an absorbent material.

15. A gas-delivery system as defined in claim 14, wherein the thermo-presurizer is thermally coupled to the gas bottle for delivering heat to the gas bottle.

16. A gas-delivery system as defined in claim 15, wherein the thermo-pressurizer comprises:
a heating mechanism thermally coupled to the gas bottle for selectively causing molecules of the gas to be released from the absorbent material; and
a control mechanism electrically coupled to the heating mechanism for elevating the temperature of the heating mechanism upon detection of a predetermined condition of the gas bottle.

17. A gas-delivery system as defined in claim 16, wherein the control mechanism is operable to elevate the temperature of the heating mechanism upon the detection of an apparent empty condition of the gas bottle.

18. A gas-delivery system defined in claim 17, wherein the control mechanism is operable to elevate the temperature of the heating mechanism by causing current to flow in the heating mechanism.

19. A gas-delivery system as defined in claim 16, wherein the heating mechanism is a blanket that conforms to the contour of the gas bottle and the control mechanism is a temperature controller.

20. A gas-delivery system as defined in claim 19, wherein the control mechanism is operable to elevate the temperature of the heating mechanism upon the detection of an apparent empty condition of the gas bottle.

21. A gas-delivery system defined in claim 20, wherein the control mechanism is operable to elevate the temperature of the heating mechanism by causing current to flow in the heating mechanism.

22. In a semiconductor device fabrication process, a method of extending the operating life of a low-pressure gas bottle that contains a gas immersed in an absorbent material, the method comprising the steps:
disposing a heating blanket in proximity to the gas bottle so as to be thermally coupled to the gas bottle;
electrically coupling the heating blanket to a source of current;
detecting a predetermined condition of the gas bottle; and
in response to detection of the predetermined condition, causing current to be supplied to the heating blanket.

23. A method as defined in 22, wherein the predetermined condition is an apparent empty state of the gas bottle.

24. A method as defined in claim 23, wherein the source of a current is a temperature controller.

25. A method as defined in claim 22, wherein supplying current to the heating blanket causes the heating blanket to generate heat, thereby raising the temperature of contents of the gas bottle and causing gas molecules to be released from the absorbent material.

26. A method as defined in claim 25, wherein the predetermined condition is an apparent empty state of the gas bottle.

27. A method as defined in claim 26, wherein the source of a current is a temperature controller.

28. A method of enhancing the amount of gas extracted from a low-pressure gas bottle used to supply gas in a semiconductor device fabrication process, the method comprising the steps of:
coupling the gas bottle to a thermo-pressurizer;
detecting a decrease in the flow of gas from the gas bottle;
in response to the detection of a decrease in the flow of gas from the gas bottle, operating the thermo-pressurizer so as to increase the flow of gas from the gas bottle.

29. A method as defined in claim 28, wherein the flow of gas from the gas bottle is increased by applying heat to the gas bottle.

30. A method as defined in claim 29, wherein the thermo-pressurizer comprises:
heating means for thermally coupling the gas bottle and for causing gas molecules to be released from an absorbent material used in the gas bottle; and
control means electrically coupled to the heating means for elevating the temperature of the heating means upon the detection of a decrease in the flow of gas from the gas bottle.

31. A method as defined in claim 28, wherein the flow of gas from the gas bottle is increased by increasing the pressure with the gas bottle.

32. A method as defined in claim 30, wherein the thermo-pressurizer comprises:
heating means for thermally coupling the gas bottle and for causing gas molecules to be released from an absorbent material used in the gas bottle; and
control means electrically coupled to the heating means for elevating the temperature of the heating means upon the detection of a decrease in the flow of gas from the gas bottle.

33. A method as defined in claim 28, wherein the flow of gas from the gas bottle is increased by causing gas molecules to be released from an absorbent material in the gas bottle.

34. A method as defined in claim 31, wherein the thermo-pressurizer comprises:
heating means for thermally coupling the gas bottle and for causing gas molecules to be released from an absorbent material used in the gas bottle; and
control means electrically coupled to the heating means for elevating the temperature of the heating means upon the detection of a decrease in the flow of gas from the gas bottle.

35. A method as defined in claim 28, wherein the thermo-pressurizer comprises:
heating means for thermally coupling the gas bottle and for causing gas molecules to be released from an absorbent material used in the gas bottle; and
control means electrically coupled to the heating means for elevating the temperature of the heating means upon the detection of a decrease in the flow of gas from the gas bottle.

36. A method as defined in claim 35, wherein the heating means is a blanket that conforms to the contour of the gas bottle and the control means is a temperature controller.

37. A method as defined in claim 36, wherein the control means is a temperature controller that operates to supply current to the heating blanket when a decrease is detected the flow of gas from the gas bottle.

38. A method of enhancing the operation of a gas-delivery system that includes a gas container and energy transfer means, the method comprising the steps:
monitoring a predetermined operational characteristic of the gas delivery system; and
upon detection of an anticipated state of the predetermined operational characteristic, supplying energy to the gas container so as to enhance the flow of gas from the gas container.

39. A method as defined in claim 38, wherein upon detection of an apparent empty condition of the gas container, a thermo-pressurizer is operated so as to deliver energy to the gas container.

40. A method as defined in claim 39, wherein the thermo-pressurizer comprises:
first means coupled to the gas container for delivering energy to the gas container upon detection of an apparent empty condition; and
second means electrically coupled to the first means for causing the first means to deliver energy to the gas container.

41. A method as defined in claim 40, wherein the thermo-pressurizer comprises:
heating means for thermally coupling to the gas container and for causing gas molecules to be released from an absorbent material used in the gas container; and
control means electrically coupled to the heating means for causing the temperature of the heating means to be elevated upon the detection of a predetermined condition of the gas container.
